(19) United States
(12) Patent Application Publication
(10) Pub. No.: US 2024/0299926 A1
(43) Pub. Date: Sep. 12, 2024

(54) METERING HEAD AND FLUIDIC SYSTEM FOR RECEIVING AND METERING AT LEAST ONE MEDIUM

(71) Applicant: FRAUNHOFER-GESELLSCHAFT ZUR FÖRDERUNG DER ANGEWANDTEN FORSCHUNG E.V., München (DE)

(72) Inventors: Christian FREESE, Mainz (DE); Peter SPANG, Gau-Bickelheim (DE)

(21) Appl. No.: 18/559,147

(22) PCT Filed: May 4, 2022
(86) PCT No.: PCT/EP2022/061985

§ 371 Date: May 31, 2024

(30) Foreign Application Priority Data
May 6, 2021 (DE) 102021204570.7

(51) Int. Cl. B01L 3/02

(52) U.S. Cl. CPC B01L 3/0265; B01L 2200/143; B01L 2300/0627; B01L 2300/0645

(57) ABSTRACT

A metering head for receiving and metering at least one medium, the metering head including: —one or multiple media access points; —at least two dispensing terminals each having at least one media outlet; and —fluid lines, which connect the one or multiple media access points to the at least one media outlet of the at least two dispensing terminals. In at least one of the fluid lines, an actively controllable element for manipulating and/or detecting the medium in the fluid lines is inserted. A fluidic system, including: —a metering head of this type; —a microfluidic cartridge; and —at least one connecting element for fluidically connecting the metering head to the microfluidic cartridge. The dispensing terminal is designed to indirectly or directly receive the connecting element. The microfluidic cartridge includes: —at least one inlet opening for connecting to the at least one connecting element; and —a channel structure fluidically connected to the inlet opening.

### FIELD OF THE INVENTION

The invention relates to a metering head for receiving and metering at least one medium, in particular for microfluidic applications, having one or multiple media inlets, at least two dispensing terminals each having at least one media outlet and fluid lines connecting the one or multiple media inlets to the at least one media outlet of the at least two dispensing terminals.

### BACKGROUND OF THE INVENTION

The invention can be classified both in the field of pipetting heads and in the field of fluidic lab-on-a-chip systems. Prior art in these fields can be found, for example, in the documents US 2010/0187452 A1, DE 102 04 414 A1, DE 10 2008 042 071 A1, US 2018/0372598 A1, DE 10 2020 201 143 A1, DE 10 2007 018 752 A1, WO 2017/124104, US 2013/0202453 A1, EP 3 501 655 A1 or US 2018/0353958 A1.

Pipettes and multichannel pipettes that work according to the reciprocating piston mechanism are known. Associated problems are that the use of such pipettes is limited to given volumes, requiring the use of different pipette types for different volumes, which in turn accommodate different sizes of pipette tips. In other words, a single multichannel pipette or a single multichannel pipette head is not sufficient to precisely pipette liquids with different volumes. This renders the use of these pipette types, especially multichannel pipettes, in automated pipetting systems complex. Moreover, these reciprocating pipettes are fixed at a certain pressure level, which means that the pressure cannot be varied.

Metering heads of the above-mentioned type solve these problems. By way of example, reference is made to the disclosure DE 10 2020 201 143 A1. It describes a metering device with a metering channel system extending between a fluid feed opening and a plurality of fluid discharge openings. The fluid to be metered is fed in via the fluid feed opening and can be discharged again in a metered manner via the fluid discharge openings. In principle, it was also recognized as possible to equip the metering channel system with multiple fluid feed openings in order to enable simultaneous multiple feeds of the fluid to be metered or different fluids that can be mixed within the metering channel system. This allows the metered dispensing of a fluid into carrier substrates, for example into so-called microtiter plates, in a partially automated and efficient manner.

Neither the known metering heads nor the pipettes and multichannel pipettes described above allow, for example, the handling of different liquids or the draining of different liquids in individual channels at different times. The known metering systems or pipette systems are therefore only suitable for universal use to a limited extent.

Unlike the dispensing of fluids in microtiter plates, the fluidics in the control of microfluidic lab-on-a-chip systems is predominantly operated via at least one syringe pump or the like installed in an operator device. Fluidic interfaces for connecting a microfluidic chip, also summarised here under the more general term “microfluidic cartridge”, are usually permanently installed in the operating device. For example, positioning pins and a mechanism for positioning the chip and sealing the interface are required to ensure a reliable connection between the operator device and the microfluidic cartridge. Many chip systems have a complex infrastructure for distributing samples or reagents, as well as mixing structures and other functional structural units (e.g. valves). As a result, the fluidic interfaces and the chip structure are complex. Process sequences for elaborate protocols are complex and error-prone, and in some cases cannot be implemented, especially if large sample volumes are used, which are subsequently processed into small analyte volumes in the system. Production is time-consuming and costly. Automated loading of the chip system with reagents is particularly difficult. In addition, the operator devices and chip systems are rigid when used, as they are designed for fixed, i.e. recurring processes. As such, flexibility is lacking.

The reciprocating pipettes described are not suitable to be used as actuators in automated systems. Especially when using and controlling microfluidic systems, a combination of pump, valve and possibly other components are always required alongside the pipetting unit. This makes it complex to implement complete systems. Moreover, the transfer of liquids/analytes is carried out manually to enable analysis on microfluidic cartridges. The supply without air bubbles is achieved by a chip-internal media reservoir (collecting funnel) and the subsequent transfer in the chip system via pressure and valve control and/or by means of capillary forces. It is also possible to draw the volumes into a syringe and then inject and move them in the chip system. The pre-storage of liquid reagents, washing solutions, beads, particles, antibodies and other assay-relevant liquids is implemented on the chip using so-called blisters or the like, which makes the chip system extremely costly to manufacture. To avoid this problem, the required liquids are stored upstream in the operating device. Actuation by individual liquid circuits, which have to be controlled by respective pumps, increases the manufacturing costs and the manufacturing effort.

### SUMMARY OF THE INVENTION

These and numerous other problems are solved by the invention, enabling it to be used in a considerably wider range of applications. Accordingly, the task is to provide a highly automatable metering head for a wide range of applications.

The task is solved in accordance with one aspect of the invention by a metering head of the type mentioned at the beginning, which is further characterised in that an actively controllable element for manipulating and/or detecting the medium in the fluid lines is connected in at least one of the fluid lines.

This lays the foundation for universal use of the metering head and, in particular, for transferring functionalities for recurring processes in microfluidic lab-on-chip systems from the microfluidic cartridge to the metering head or the interface between the metering head and the microfluidic cartridge. The fact that an actively controllable element for manipulating and/or detecting the medium in the fluid lines is switched on in at least one of the fluid lines of the metering head means that the corresponding functionality on the microfluidic cartridge can be omitted.

Furthermore, the metering head according to the invention can still be used as a single or multi-channel pipette, but the application is not limited to liquid transfer with pipette tips. Rather, the metering head can also be operated with other connectable auxiliary means, hereinafter referred to as “connecting element”, (capillaries, dosing needles, cannulas, or generally microfluidic head adapters) or by several media outlets per dispensing terminals for carrying out process steps within a pipette tip equipped with corresponding functional elements. This can be done manually or, in particular, automatically.

The different media can be reagents or also transport media such as air or rinsing media. From a functional point of view, one of the media can therefore be used as an actuator and the other(s) can be consumption media. Irrespective of the media function and the aggregate state, the terms metering, distributing, moving, transporting or even conveying are used here to standardize the conveying of the media through the fluidic structure.

Preparatory work outside the microfluidic cartridge can be carried out in the metering head according to the invention in units between 1-10,000 μL. The same metering head can then be used to process volumes on the microfluidic cartridge in much smaller volumes of typically 10-500 μL. The volumes to be moved per process step are therefore preferably in the range of less than 10 ml, preferably less than or equal to 1 ml and greater than or equal to 1 μL when operating a microfluidic cartridge. In the metering head according to the invention, the smallest structure sizes of the fluid structure transverse to the direction of flow are smaller than 5 mm, preferably smaller than 2 mm, particularly preferably smaller than 1 mm.

Media inlets, media outlets and fluid lines are in contact with the media and are summarized here alongside other media-carrying elements under the term fluidic structure. The functional unit around the media outlets is referred to as the dispensing terminals. A connecting element, for example in the form of a pipette tip, is assigned to each dispensing terminal, via which the media is dispensed from the metering head into a connected carrier substrate or a microfluidic cartridge. Accordingly, the dispensing terminals are configured to directly accommodate a connecting element, preferably in a liquid-tight manner, or to indirectly accommodate a connecting element via a connecting piece (adapter).

The metering head has a substrate, for example made of a polymer material, metal, non-ferrous metal, silicon, glass or ceramic, in which the fluid lines are formed as channels. The dispensing terminals are moulded onto the substrate, preferably in one piece. For example, the metering head can be manufactured using embossing, injection moulding or deep-drawing technology or using additive manufacturing processes (3D printing). Alternatively, the fluidic structures can also be drilled in sections or incorporated into the substrate material using an erosion process.

According to a preferred embodiment, the metering head for receiving and metering at least two media has at least two fluidically separate media inlets and the one or multiple dispensing terminals each have at least two fluidically separate media outlets.

Preferably, the fluid lines can comprise a mixing section for combining at least two media to form a mixture. For example, this makes it possible to automatically premix various reagents immediately before the reaction, prior to combining them with an analyte (sample) in a carrier substrate or a microfluidic cartridge. The metering head thus does not come into contact with the sample material and remains contamination-free. Any residual reagents can be removed by rinsing. At the same time, a recurring functionality is outsourced to the metering head, which simplifies the assembly of the microfluidic cartridge.

Preferably, the fluid lines provide at least two alternative or parallel connections between the media inlet or inlets and the at least one media outlet of the at least two dispensing terminals, wherein the actively actuated element is a valve for selecting none, one or multiple of the connections.

The valve can be a diaphragm valve, rotary valve, slide valve, piezo valve or a fast-switching (solenoid) valve, for example.

When this refers to a fluid line “connected” to a media inlet or a fluid line or line branch connected to a media outlet, this basically also includes indirectly connected fluid lines or line branches with interposed functional elements or other fluidic structures and fluid lines or line branches that can be temporarily disconnected, for example by means of a valve.

The actively controllable element is preferably a valve, wherein the substrate has a sealing surface, wherein the valve has a valve body which is arranged movably relative to the substrate, has a sealing surface and defines at least one channel for the optional connection and/or separation of fluid lines in the substrate, and wherein the sealing surface of the valve body and the sealing surface of the substrate are in liquid-tight contact with one another.

Further preferably, the valve body is pressed with its sealing surface against the sealing surface of the substrate by means of a pressure ring connected to the substrate, preferably in an interlocking manner, or by means of a clamp element connected to the substrate with a positive fit, wherein the pressure ring or the clamp element and/or the valve body are at least partially elastic.

According to another aspect, the actively controllable element preferably comprises a pump for changing the conveying quantity and/or the conveying pressure of the medium or the mixture in the at least one fluid line.

According to still another aspect, the actively controllable element preferably comprises a sensor unit for detecting the presence, the volume, a physical, optical, chemical or biological property of the at least one medium or mixture or a combination of such measuring units.

It is advantageous if the sensor unit comprises an electrode arrangement with a transmitting electrode, a receiving electrode and a first shielding electrode, which are arranged coplanar on a plane and can be positioned parallel to the fluid line and above or below adjacent to the fluid line, wherein the transmitting electrode and the receiving electrode are directly capacitively coupled by each having an adjacent edge with a dielectric in between, preferably no shielding is provided between the transmitting electrode and the receiving electrode.

According to still another aspect, the actively controllable element comprises a heating element, a cooling element, an element for generating a magnetic field, an element for generating an electric field, an element for coupling electromagnetic energy into the at least one medium or into the mixture, or a combination of such elements.

The metering head preferably comprises a control unit connected to the actively controllable element, wherein the control unit particularly preferably comprises a digital computing unit. It is also preferable if the metering head has actuators for the movable, actively controllable elements.

In this way, the control unit is designed to be programmable and the metering head can be used autonomously, for example with the help of line gantries, spatial gantries or robots or cobot systems.

A power supply, a data conductor and supply lines for the media may also be required as external feeds. Accordingly, the metering head preferably has one or multiple interfaces and transmission means from the interfaces to the controllable elements and/or to the actuators, such as electrical conductors, optical fibres and the like, for a power supply or more generally for a power supply and/or for data exchange.

The invention is further solved by a fluidic system, in particular a microfluidic system with a metering head of the type described above, with a microfluidic cartridge and with at least one connecting element for fluidically connecting the metering head to the microfluidic cartridge. The dispensing terminals is configured herein to directly accommodate the connecting element, preferably in a liquid-tight manner, or to indirectly accommodate the connecting element via a connection piece (adapter). The microfluidic cartridge has at least one input opening for connection to the at least one connecting element and a channel structure in fluidic connection with the input opening. The microfluidic cartridge may further comprise one or multiple sample accesses for receiving a sample to be analysed, wherein the channel structure is then designed to connect the input opening to the sample access.

The unit consisting of metering head and connection element and, if applicable, connection piece is referred to herein as the “metering system”, while the metering system together with the microfluidic cartridge forms the (micro) fluidic system. The connecting element is used for the fluidic connection of the metering head to a carrier substrate, such as a microtiter plate or a microfluidic cartridge, depending on how the metering head is currently being used. The connecting element is preferably selected from the group consisting of pipette tip, capillary, dispensing needle, cannula, Luer connector, channel orifice with sealing element, nozzle and microfluidic head adapter. The media are dispensed from the metering head into a connected carrier substrate, such as a microtiter plate or a microfluidic cartridge, via the connecting element. A head adapter is a connecting element between one or preferably multiple connection terminals and one or preferably multiple inlets of a microfluidic cartridge. Accordingly, it is specially adapted for use together with a specific microfluidic cartridge. An elastomer seal or a moulded elastic sealing element, for example in the form of a sealing lip, or simply a conical or flat sealing surface can be considered as a sealing element for the channel orifice,

For its part, the microfluidic cartridge has a base plate made of metal, non-ferrous metal, silicon, glass or ceramic and preferably of a polymer material, in which the input opening, optionally a sample access and the channel structure are formed. For example, the microfluidic cartridge can be manufactured using embossing, injection moulding or deep-drawing technology or using additive manufacturing processes (3D printing). Alternatively, the channel structure can also be drilled in sections or incorporated into the substrate material using an erosion process.

Particularly in conjunction with two or more dispensing terminals, several input openings of a microfluidic cartridge can be fluidically controlled with one metering head. This allows the cartridge to be operated with different fluid delivery directions. For example, a sample, a reagent or a reaction product in the channel structure can be moved back and forth several times as required and thus also transported back into a chamber or channel section that has already been used. This allows the channel structure to be designed with less redundancy and therefore more compactly and cost-effectively, even for complex reaction processes.

The dispensing terminals are suitable for accommodating such a connecting element, in particular in a liquid-tight manner, which can be replaced after use. After changing the connecting element, the metering head is immediately available for reuse. The dispensing terminals preferably have a sealing element for this purpose. The sealing element can be a sealing surface or a sealing lip or an elastomer seal which, when connected, rests against a complementary sealing element of the connecting element. The dispensing terminals can, for example, comprise a frustoconical attachment as a receptacle onto which a pipette tip with a complementary inner surface can be directly attached in a liquid-tight manner. Alternatively or additionally, the dispensing terminals can have a bore or a conical countersink as a receptacle into which, for example, a cannula with a complementary outer surface can be inserted in a liquid-tight manner. In particular, the dispensing terminals can comprise a plurality of different receptacles for receiving different connecting elements. When using a connection piece, complementary sealing elements are provided between the dispensing terminals and the connection piece on the one hand and between the connection piece and the connecting element on the other. As a rule, the cone of the projection and/or the bore or countersink on or in the dispensing terminals and the respective complementary shapes of the connecting element are designed such that the connecting element is fixed in a friction-fit manner on the respective receptacle.

In addition to the sealing element, the dispensing terminals or the connection piece can also comprise a latching element which interacts with a complementary latching element on the connecting element such that the connecting element, when connected, is held on the metering head in an interlocking manner.

When using a connection piece, complementary fixing or locking elements are provided between the dispensing terminals and the connection piece. Locking elements are defined as elements suitable for automatic ejection as opposed to fixing elements. If the connection piece is to remain permanently on the metering head, fixing elements can be considered. If it is to be exchanged with the connecting element, locking elements can be considered. Locking elements can also be used as a direct connection between the dispensing terminals and the connecting element (i.e. without a connection piece).

Furthermore, the fluidic system can be characterised by a standardised mounting system in which the dispensing terminals as well as a plurality of connecting elements each have standardised complementary shapes, so that the metering head can be equipped with a plurality of connecting elements.

In particular, the microfluidic cartridge does not have an actively actuated moving element for controlling a fluid flow in the channel structure. This functionality is completely outsourced to the metering head, for example by the valve described above, so that the cartridge can be manufactured very cost-effectively and operated without an operator device with complex mechanisms. The same consideration applies to the pump described above, the sensor unit, the heating element, the cooling element, the element for generating a magnetic field, the element for generating an electrical field, the element for coupling electromagnetic energy and the temperature sensor. All these functional elements allow the corresponding functionalities to be transferred from the microfluidic cartridge to the metering head, so that only a few and advantageously no active elements are required in the microfluidic cartridge.

Preferably, the metering head, in particular the dispensing terminals, and/or the connecting element or, if present, the connection piece, has means for retaining an inflow of fluids from the microfluidic cartridge into the metering head.

Contamination of the metering head can thus be avoided. The means for retaining an inflow of fluids through the media outlets into the metering head are preferably arranged in the region of the media outlets in the one or multiple dispensing terminals. They are preferably formed by a filter, a membrane or a barrier.

Particularly preferably, a Teflon membrane (more precisely, a membrane made of polytetrafluoroethylene, PTFE) is arranged in the region of the media outlets at or in the one or multiple dispensing terminals. Such a Teflon membrane prevents liquids from penetrating the system, especially in the air dispensing terminals or gas dispensing terminals. If the Teflon diaphragm is wetted from the outside, it fluidically seals the media outlet by closing the pores due to the surface tension of the liquid and preventing any medium from penetrating the metering head from the outside. If the Teflon diaphragm is wetted from the outside, it fluidically seals the media outlet by closing the pores thanks to the surface tension of the liquid, preventing any medium from penetrating the metering head from the outside. In the worst-case scenario, if the membrane remains wet for a longer period of time, it can be replaced. Preferably, the means for retaining, i.e. in particular the filters, membranes or barriers, are connected to the one or multiple dispensing terminals by thermal welding, bonding (substance-to-substance) or pressing (form-fit and friction-fit).

According to an advantageous further development, the dispensing terminals have a sensor element for detecting the presence of a connecting element. The sensor element can, for example, be formed by electrodes in the metering head, for example adjacent to or in the region of the dispensing terminals, which are guided to the surface, for example in the region of the sealing surface. The connecting element is either made entirely of a conductive material or has a conductive contact section at least on the surface, for example in the region of the complementary sealing surface, which connects the electrodes electronically when the connecting element is attached. This can improve the operational safety of the invention with a high degree of automation, i.e. with as little human control and intervention as possible.

Particularly preferably, the fluidic system comprises at least one connection piece, wherein the one or multiple dispensing terminals each have a connecting structure for receiving and a locking element for releasably fixing one of the connection pieces in each case, wherein the connection piece has a fluid channel, wherein the connecting structure and the connection piece can be plugged into one another in an insertion direction and the fluid channel, when inserted, and the media outlet communicate fluidically, wherein the locking element is arranged in the dispensing terminals so as to be movable in a guide direction transverse to the insertion direction between a locking position and a release position, wherein the locking element, when inserted, locks the connection piece in the locking position and releases it in the release position, and wherein the connection piece is configured to directly receive the connecting element.

The dispensing terminals can be configured simultaneously for directly receiving the connecting element, as described above, and for indirectly receiving the connecting element via the connection piece described above by means of a connecting structure and locking element.

It is also advantageous if the one or multiple dispensing terminals each have at least two fluidically separate media outlets and the connection piece has at least two fluidically separate fluid channels, wherein each of the at least two fluid channels, when inserted, communicates fluidically with one of the at least two media outlets.

When using a connection piece, the dispensing terminals preferably have a sensor element for detecting the presence of a connection piece, as described above, for the purpose of increased operational safety. The sensor element can also be formed, for example, by electrodes in the metering head, for example adjacent to or in the region of the dispensing terminals, which are guided to the surface, for example in the region of the cylindrical bore. The connection piece is either made entirely of a conductive material or has a conductive contact section at least on the surface, for example in the region of the hollow cylinder, which connects the electrodes electronically when the connection piece is attached.

Particularly preferably, the dispensing terminals and the locking element are configured to automatically eject a connection piece.

According to an advantageous embodiment of the invention, the connection piece optionally has a functional element integrated into the fluid channel, in particular an actively controllable element for manipulating and/or detecting the medium, a passive mixing structure, an activatable mixer, a heating device, a cooling device, a passive or controllable magnet, a temperature sensor, an electrode or a means for retaining an inflow of fluids from the microfluidic cartridge into the metering head.

Due to the means integrated in the connection piece for retaining an inflow of fluids from the microfluidic cartridge into the metering head, this means is assigned to the connection piece designed for single use and is disposed of with the connection piece after use. This further reduces the risk of contamination. Additionally or alternatively to the connection piece, however, the dispensing terminals and/or the connecting element can also have means for retaining an inflow of fluids through the media outlets into the metering head. This would reduce the probability of a fluid contaminated with the sample to be analysed, for example, entering at each stage from the connecting element via the connection piece to the metering head. Since both the connecting element and the connection piece are designed for single use, the only crucial factor is that the sample to be analysed must never be allowed to reach the metering head from the microfluidic cartridge, which is also designed for single use, whereas consumables could be premixed in the metering head or in the connecting element in a timely manner and then dosed out.

The connecting element also has an optional integrated functional element. The integrated functional element is preferably selected from the group of mixing structure, permanent magnet, filter element and fragmenting element. An integrated mixing structure can be used for “late mixing” of the two media output from the at least two fluidically separated media outlets immediately prior to input into the carrier substrate or microfluidic cartridge. An integrated permanent magnet can be used for filtering magnetic particles and an integrated filter element for filtering cells, nanoparticles, polymers, exosomes, liposomes, etc. in particular. With an integrated fragmentation element, RNA/DNA can be fragmented mechanically, with the help of ultrasound or by means of other strong shear forces. Such methods are known as “shotgun sequencing” and “French press”.

The functionalisation of the connecting element is not only, but also particularly, possible in the case of a head adapter. This head adapter can have as an integrated functional element, in particular one or multiple actively controllable elements, for manipulating and/or detecting the medium, a passive mixing structure, an activatable mixer, a heating device, a cooling device, a passive or controllable magnet, a means for retaining an inflow of fluids from the microfluidic cartridge into the metering head.

Advantageously, the microfluidic cartridge comprises a storage volume connected to the channel structure, for example for reagents. In this way, certain reagents or consumables can be stored in precisely sufficient quantities on the cartridge itself and can be controlled by means of the media flows on the metering head at a predetermined time, i.e. conveyed into a reaction volume on the cartridge, for example.

The at least one connecting element and the input opening preferably have interlocking coupling elements for liquid-tight connection.

Furthermore, the input opening in the microfluidic cartridge preferably has a funnel-shaped centring opening. This serves to ensure reliable connection of the connecting element to the cartridge during manual or automatic handling of the metering head.

Advantageously, the microfluidic cartridge has a sample access port for receiving a sample to be analysed and a channel structure connecting the input opening to the sample access port. In this embodiment of the invention, the microfluidic cartridge can be a microfluidic measuring chip. Particularly preferably, the microfluidic measuring chip is configured for carrying out measurements of the emission and/or scattering of light by a fluid sample in an operator device, wherein the measuring chip has a base plate made of a transparent polymer material and the channel structure is formed in the base plate and comprises at least one sensing cell for receiving a fluid sample and fluid channels for the supply and discharge of fluid to and from the sensing cell.

Furthermore, one or multiple mirror surfaces can be provided in the base plate outside the sensing cell, which is arranged in the base plate in such a way that light emitted and/or scattered by a fluid sample in the sensing cell is always reflected thereon into the polymer material of the base plate and directed from the measuring chip towards a light detector provided in the operator device.

A further aspect of the invention provides that at least one of the components metering head, microfluidic cartridge, connecting element and connection piece is provided with a machine-readable code, in particular with an RFID tag, for automatic recognition thereof. This allows the handling of the components to be further automated.

Preferably, a distribution structure is provided in which a fluid line connected to one of the media inlets branches into at least two line branches each connected to one media outlet per dispensing terminal.

When this refers to a fluid line “connected” to a media inlet or a fluid line or line branch connected to a media outlet, this also includes indirectly connected fluid lines or line branches with interposed functional elements or other fluidic structures and fluid lines or line branches that can be temporarily disconnected, for example by means of a valve.

In an advantageous embodiment, the distribution structure comprises at least one single branching, at which the branching fluid line splits into two line branches. By arranging n>1 successive single branches in the direction of flow in the fluid line connected to a media inlet, the fluid line can be branched into 2ⁿ≥m>n line branches each connected to a media outlet.

As an alternative to an arrangement of multiple single branches in series or elsewhere in addition thereto, the metering head according to a further aspect of the invention has at least three dispensing terminals and a distribution structure with multiple branching are provided, wherein in the multiple branching a fluid line connected to one of the at least two media inlets branches into at least three line branches each connected to a media outlet per dispensing terminal, wherein the multiple branching has a distribution chamber with a longitudinal direction, along which the distribution chamber tapers downstream in steps or continuously from a largest cross-section to a smallest cross-section, wherein the fluid line connected to the media inlet opens into the distribution chamber in the region of the largest cross-section and the at least three line branches, each connected to a media outlet per dispensing terminal, branch off from the distribution chamber successively in the longitudinal direction at different cross-sections.

Terms such as “downstream” or “in the direction of flow” always refer to the direction along which the media in the fluid lines flow from the media inlets to the media outlets.

The distribution chamber is preferably designed as a stepped bore. This can have advantages in terms of production technology. Alternatively, the distribution chamber can also be a wedge-shaped or stepped chamber with a rectangular cross-section.

### BRIEF DESCRIPTION OF THE DRAWINGS

The invention is explained in more detail below with reference to the drawings. In the figures:

FIG. 1 a perspective view of a first exemplary embodiment of a fluidic system;

FIG. 2 a rear view of the metering head of the first exemplary embodiment of the fluidic system;

FIG. 3 a side view of the first exemplary embodiment of the fluidic system;

FIG. 4A a sectional view demonstrating the coupling of a pipette tip to the cartridge;

FIG. 4B a sectional view demonstrating an alternative coupling of a pipette tip to the cartridge;

FIG. 5 an enlarged view of an embodiment of a dispensing terminals in lateral section;

FIG. 6 an enlarged view of a connection piece compatible with the dispensing terminals shown in FIG. 5;

FIG. 7 a perspective view of a second exemplary embodiment of a metering head with integrated valves;

FIG. 8 a detailed view of the valve in the second exemplary embodiment of the metering head;

FIG. 9 a perspective view of a third exemplary embodiment of a metering head with integrated pump;

FIG. 10 a perspective view of a fourth exemplary embodiment of a metering head with integrated valves; and;

FIG. 11 an enlarged view of an alternative connection piece;

FIG. 12 a perspective view of a fifth exemplary embodiment of a metering head with integrated metering section.

### DETAILED DESCRIPTION OF THE INVENTION

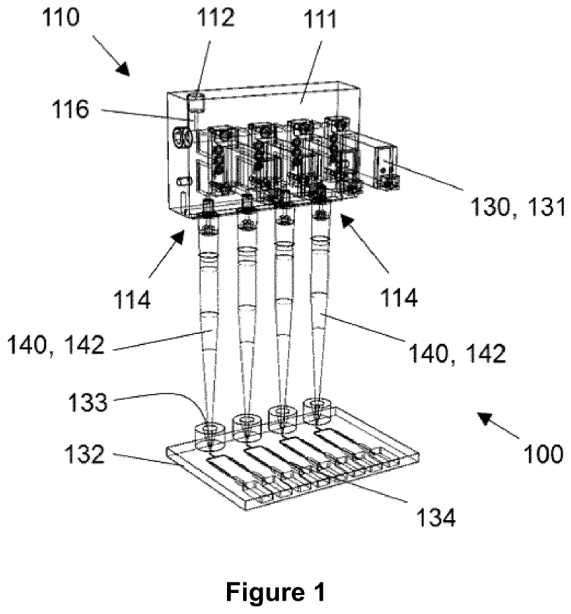

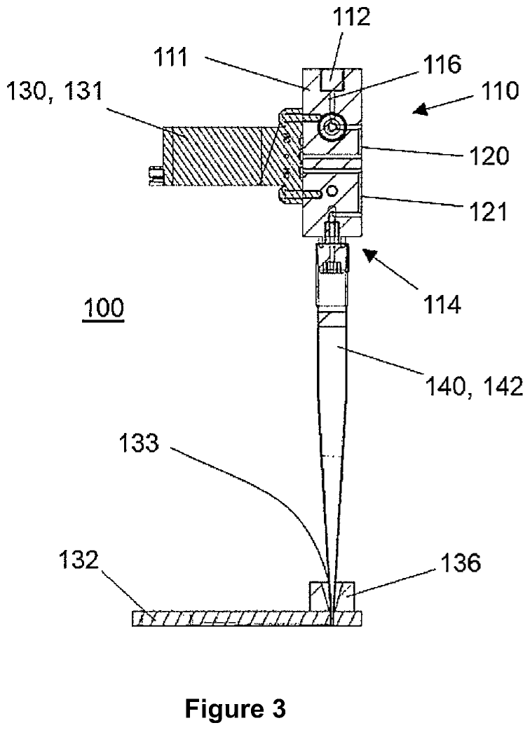

In FIGS. 1 through 3, the invention is explained in more detail with reference to a first exemplary embodiment of a fluidic system 100 and the corresponding metering head 110.

The metering head 110 has a substrate 111 in which fluidic structures are moulded. In this exemplary embodiment, the fluid structures in the metering head 110 comprise a media inlet 112 and four dispensing terminals 114, each with a media outlet 118, for dispensing the media and fluid lines 116, 120 connecting the media inlet 112 to the dispensing terminals 114. For the purpose of distributing the medium to the four dispensing terminals 114, the fluidic structure comprises a distribution structure in which the fluid line 116 connected to the media inlet 112 branches into four line branches 120 each connected to a media outlet 118. For this purpose, the distribution structure has a quadruple branch 122 with a distribution chamber 123 in the form of a stepped bore with a longitudinal direction along which the distribution chamber 123 tapers downstream in steps from a largest cross-section to a smallest cross-section. The fluid lines 116 connected to the media inlet 112 open into the distribution chamber 123 in the area of the largest cross-section. The four line branches 120, each connected to a media outlet 118, branch off from the distribution chamber 123 successively in the longitudinal direction at different cross-sections.

An actively controllable element 130 for manipulating the medium in the form of a valve 131 is connected into each of the line branches 120. In this embodiment, manipulating means selectively interrupting or connecting the four line branches 120, so that the media output at the four dispensing terminals 114 can be individually controlled. Thus, this is an example of a metering head with fluid lines 116 providing at least two alternative or parallel connections between the media inlet 112 and the media outlets 118 of the four dispensing terminals 114, wherein the actively controlled element is at least one valve 131 for selecting none, one or multiple of the connections.

In addition to the metering head 110, the fluidic system 100 comprises a microfluidic cartridge 132 and four connecting elements 140 for fluidically connecting the metering head 110 to the microfluidic cartridge 132. In this case, the dispensing terminals 114 are configured to directly receive the connecting elements 140. By way of example, four pipette tips 142 are shown as connecting elements 140. Depending on the application, the connecting element 140 can also be a capillary, dispensing needle, cannula, Luer connector, channel orifice with sealing element, in particular a sealing ring, nozzle or a complex microfluidic head adapter with a plurality of identical and/or different connections.

The microfluidic cartridge 132 has four input openings 133 for connection to a respective one of the connecting elements 140 and a respective channel structure 134 in fluidic connection with each of the input openings 133.

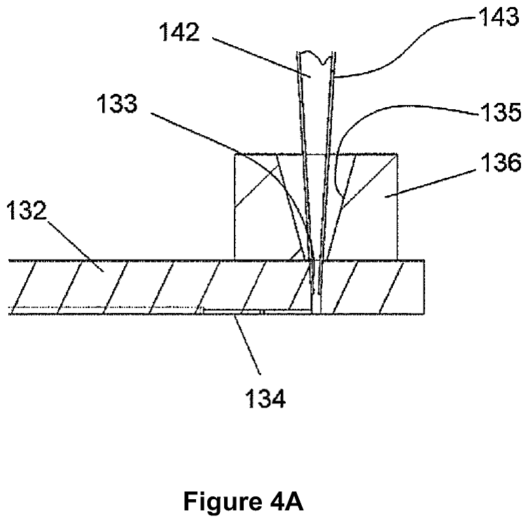

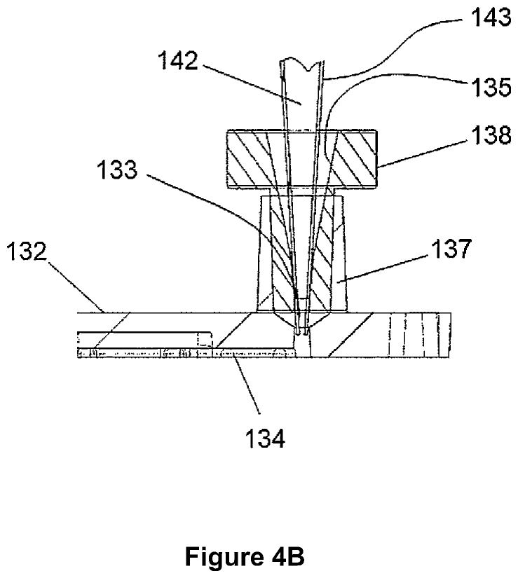

The connecting elements 140 and the input openings 133 have coupling elements that interlock in pairs for liquid-tight connection. In the case shown, these are the conical outer casing surface 143 of the pipette tip 142 on the one hand and a complementary conical inner casing surface of the input opening 133, see FIG. 4A.

In addition, the microfluidic cartridge has a funnel-shaped centring opening 135 above the input openings 133. The centring opening 135 is formed in a bushing 136 placed on the microfluidic cartridge 132, is itself conical and has a larger opening angle than the cone of the input opening 133. As a result, there is no positive-locking fit with the pipette tip 142 at this point. The centring opening 135 serves solely as an insertion aid for reliable connection of the connecting element 140 to the cartridge 132 during manual or automatic handling of the metering head 110.

FIG. 4B shows an alternative implementation of the funnel-shaped centring opening 135 above the input openings 133. Instead of the bushing 136, the cartridge has a receptacle 137 for a standard Luer connection. The receptacle is moulded or attached to the surface of the cartridge either in one piece or by joining technology (gluing, friction welding, etc.). A Luer connector 138 is inserted into the receptacle 137, on the inside of which the centring opening 135 is formed concentrically to the outer circumference.

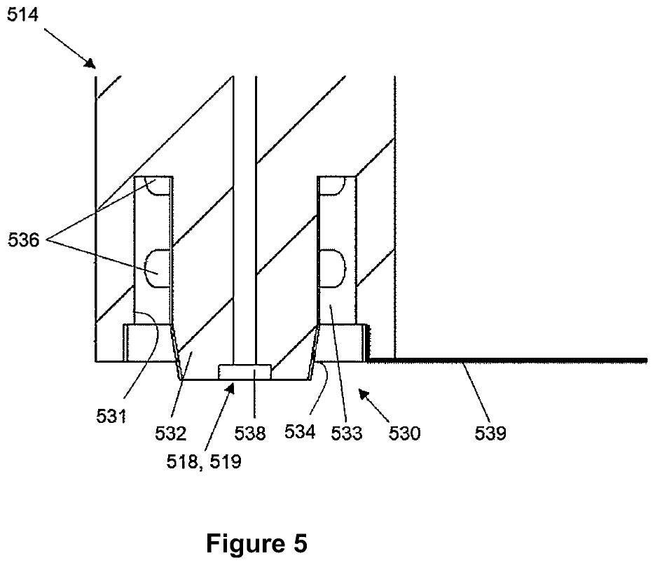

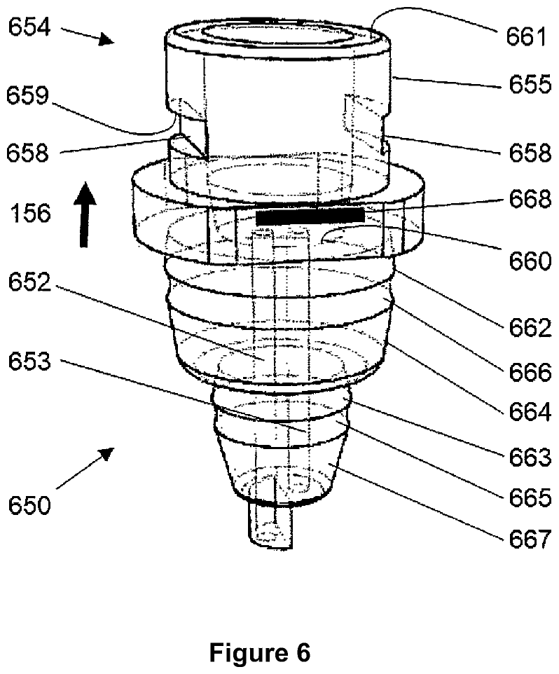

In FIG. 5, an embodiment of a dispensing terminals 514 is shown in lateral section or from below. The dispensing terminals 514 is configured to indirectly accommodate, in a liquid-tight manner, a connection piece 650 as shown in FIG. 6, which serves as an adapter between the dispensing terminals 514 and a connecting element (not shown here).

In this example, the dispensing terminals 514 and the connection piece 650 are designed to be ejected automatically or manually. In this case, it is provided that the connection piece 650 is replaced together with the connecting element after use.

The dispensing terminals 514 has a connecting structure 530 for receiving and a locking element (not shown) for releasably fixing the connection piece 650. The connecting structure 530 is formed by a cylindrical bore 531 with a coaxial centring pin 532, between which an annular gap 533 is formed. The connection piece 650 has a complementary connection structure 654 with an attachment in the form of a hollow cylinder 655, which can be inserted in an interlocking manner into the annular gap 533 in an insertion direction 656. The centring pin 532 has a centring cone 534 to facilitate insertion of the connection piece 650.

The locking element is arranged in the dispensing terminals 514 so as to be movable in a guide direction transverse to the insertion direction between a locking position and a release position. Guide channels 536 serve as guides. In the locked position, the locking element engages in corresponding guide grooves 658 in the outer wall of the hollow cylinder 653, whereby the locking element locks the connection piece 650 when inserted.

The dispensing terminals 514 have two fluidically separated media outlets 518, 519, which are arranged successively perpendicular to the plane of representation of FIG. 5. The connection piece 650 has two corresponding fluid channels 652, 653, wherein each fluid channel 652, 653 of the connection piece 650 communicates fluidically with one of the media outlets 518, 519 of the dispensing terminals 514 when inserted.

Furthermore, the dispensing terminals 514 has a recess 538 on its underside for receiving a sealing element in the form of an oval elastomer disc (not shown) with two openings for the media outlets 518, 519. The sealing element forms an axial seal which interacts with a sealing surface 660 on the base of the hollow cylinder 655.

The connection piece 650 in turn serves as an adapter between the dispensing terminals 514 and a connecting element. It has various stepped outer cross-sections 662, 663 to accommodate different connecting elements. The connection piece 650 can therefore be described as a universal adapter. Complementary conical sealing surfaces 664, 665 serve as a sealing element between the connection piece 650 and the connecting element. The cone of the sealing surfaces of the connection piece 650 and the connecting element is designed such that the connecting element is fixed in a friction-fitting manner on or in the respective receptacle. In addition, each outer cross-section is also assigned a latching element in the form of an annular groove 666, 667, which interacts with a complementary latching element in the form of an internal annular bead on the connecting element such that the connecting element, when connected, is held on the connection piece 650 in an interlocking manner.

The dispensing terminal also has two electrodes 539, which are arranged successively perpendicular to the display plane. The electrodes 539 serve as a sensor element for detecting the presence of the connection piece 650. The electrodes 539 are guided to the inner surface in the region of the cylindrical bore 531, more precisely in a shoulder at its orifice. The connection piece 650 has a conductive contact section 668 on the outer surface in the region of the hollow cylinder 655, more precisely on an annular projection, which electronically connects the electrodes 539 when the connection piece 650 is attached. The connection can be read out as a presence signal by a control unit of the metering head 110. As an alternative to an arrangement of the contact section on the outer circumference of the hollow cylinder 655, this can, for example, also be arranged on the upward-facing end face 661 of the connection piece 650, wherein the electrodes 539 are then guided outwards accordingly at the base of the cylindrical bore 531.

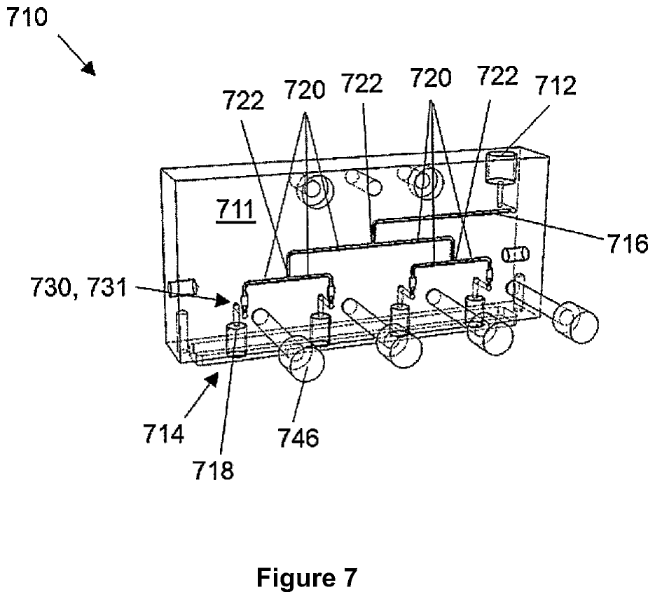

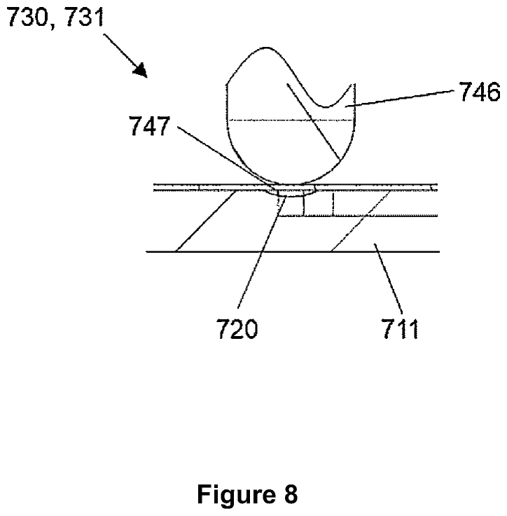

FIGS. 7 and 8 show a second embodiment of the metering head 710. The metering head 710 has a substrate 711 in which fluidic structures are moulded. In this exemplary embodiment, the fluid structures in the metering head 710 comprise a media inlet 712 for receiving a media, four dispensing terminals 714 for dispensing the media, and fluid lines 716 connecting the media inlets 712 to the dispensing terminals 714. Each of the dispensing terminals 714 has a media outlet 718.

For the purpose of distributing the medium to the four dispensing terminals 714, the fluidic structure comprises a distribution structure in which the fluid line 716 connected to the media inlet 712 branches into four line branches 720 each connected to a media outlet 718. This time, the distribution structure comprises three single branches 722, at each of which the branching fluid line 716 splits into two line branches 720. The three single branches 722 are arranged in a cascade in two rows, so that the number of line branches 720 is doubled in each level.

An actively controllable element 730 for manipulating the medium in the form of a valve 731 is connected to each of the resulting four line branches 720. In this embodiment, manipulating also means selectively interrupting or connecting the four line branches 720, so that the media output at the four dispensing terminals can be controlled individually. A stem actuated valve arrangement 745 is provided here as valve 731 in each case, which comprises a tappet 746 that can be actuated from the outside, which is guided in the substrate 711 in such a way that, when actuated, it presses on a membrane 747, which forms a wall section of the respective line branches 720, thereby elastically deflecting the membrane and pressing it against the opposite rigid wall and closing the line branch 720 in this way.

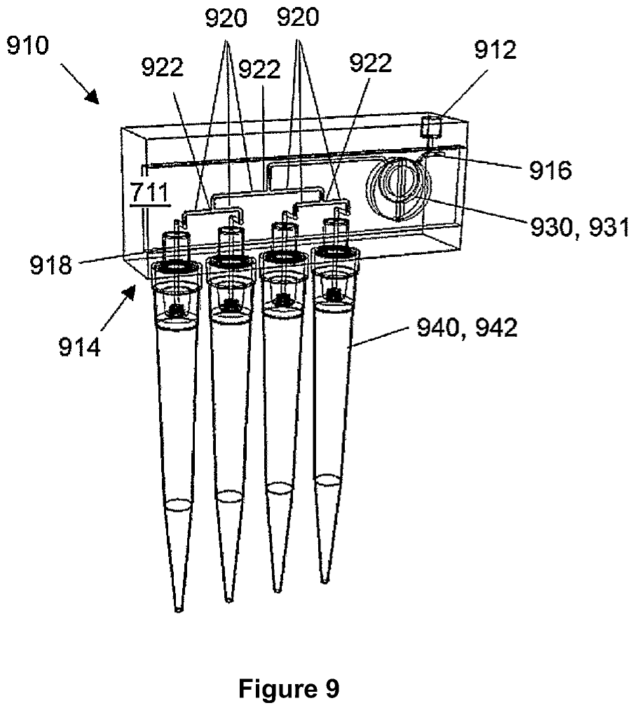

FIG. 9 shows a third embodiment of the metering head 910, which again has a substrate 911 in which fluidic structures are moulded in the form of a media inlet 912, four dispensing terminals 914 and fluid lines 916 connecting the media inlets 912 to the dispensing terminals 914. This time, the dispensing terminals 914 are again shown with connected connecting elements 940, namely pipette tips 942. Also as in the example according to FIG. 7, a distribution structure with three single branches 922 is provided for the purpose of distributing the medium to the four dispensing terminals 914, in which the fluid line 916 connected to the media inlet 912 branches into four line branches 920 each connected to a media outlet 918. In contrast to FIG. 7, a pump 931, here exemplarily a rotary vane pump, is provided here as an actively controllable element 930 for changing the conveying quantity and/or the conveying pressure of the medium in the fluid lines 916 or the line branches 920.

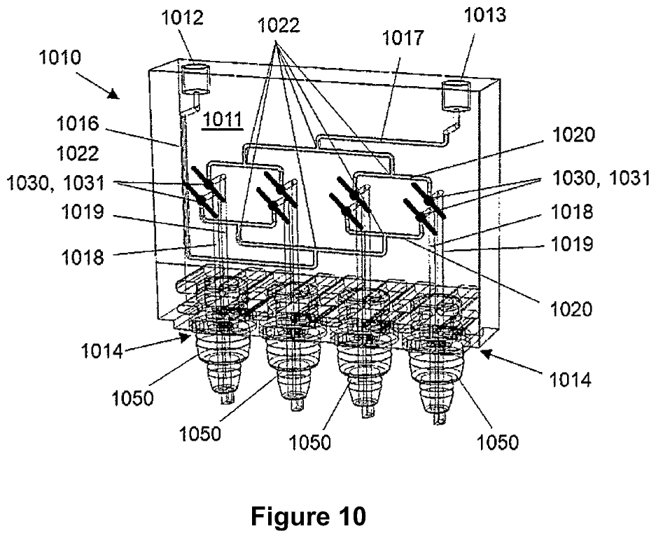

FIG. 10 shows a metering head 1010. The metering head 1010 has a substrate 1011 in which fluidic structures are moulded. In this exemplary embodiment, the fluid structures in the metering head 1010 comprise two media inlets 1012, 1013 for receiving two media, four dispensing terminals 1014 for dispensing the media and fluid lines 1016, 1017 connecting the media inlets 1012, 1013 to the dispensing terminals 1014. Each of the dispensing terminals 1014 has two fluidically separate media outlets 1018, 1019. Both media inlets 1012, 1013 are each connected to a media outlet 1018, 1019 for each outlet terminal 1014 by means of a fluidically isolated fluid line 1016, 1017. Isolated means that both fluid lines 1016, 1017 each form a direct line between the media inlets 1012, 1013 and the media outlets 1018, 1019 without the fluids coming into contact with each other.

This embodiment of the metering head 1010 serves, among other things, to distribute two media to the four media outlets 1018 of the four dispensing terminals 1014. For example, the isolated fluid lines 1016, 1017 can be used exclusively for supplying a transport medium (e.g. air) supplied via the first media inlet 1012 and a reagent medium supplied via the second media inlet 1013. In order to distribute, a distribution structure is provided in which the fluid lines 1016 connected to media inlets 1012 each branch into four line branches 1020 each connected to a media outlet 1018. For this purpose, the distribution structure comprises three single branches 1022 for each fluid line 1016, 1017, at which the branching fluid lines 1016, 1017 are each split into two line branches 1020. The three single branches 1022 are each arranged in a cascade in two rows, so that the number of line points 1020 is doubled in each level.

The single branches 1022 and the fluid lines 1016, 1017 lie intermittently between the media inlets 1012, 1013 and the dispensing terminals 1014 in the same plane and only jump back to different planes directly in front of the media outlets 1018, 1019. This can be advantageous when forming the channel structures which form the fluid line sections lying in a common plane close to the surface.

Furthermore, four identical connection pieces 1050 are provided which serve as adapters between the dispensing terminals 1014 of the metering head 1010 and a connecting element 1040 (not shown here). The connection pieces are automatically or manually ejectably connected to the metering head 1010 and, with the exception of missing contact sections, have the shape of the connection pieces described in connection with FIG. 6.

Eight valves 1031 are provided as actively controllable elements 1030, more precisely this time foil valves with valve plungers made of either shape memory alloys, electro-active polymers, piezo or other materials, which can be deflected by influencing in order to actuate the foil valves. The valves are connected in the eight branched line sections 1020 immediately before the return to the levels of the media outlets 1018, 1019.

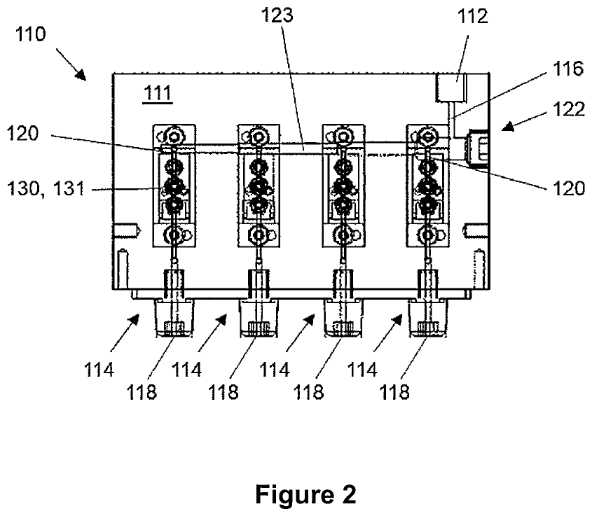

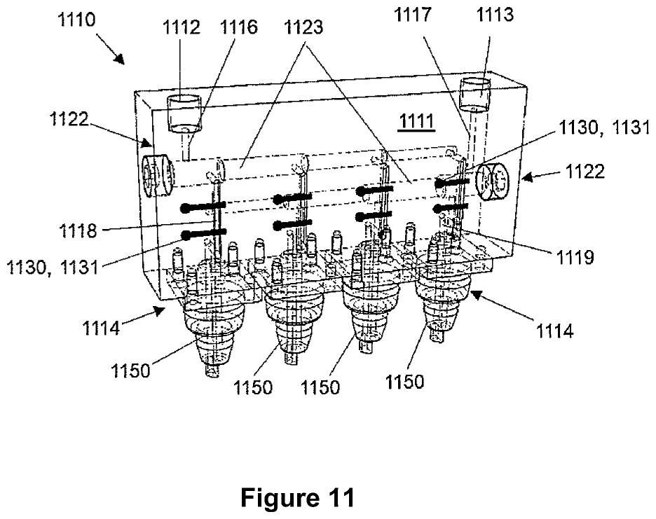

The metering head 1110 according to FIG. 11 differs from the previous examples in that in lieu of the distribution structure with three single branches per fluid lines 1116, 1117, a distribution structure with a quadruple branch 1122 per fluid line 1116, 1117 is moulded into the substrate 1111. The quadruple branches 1122 each have a distribution chamber 1123 as described in connection with FIG. 2.

The distribution chambers 1123 taper downstream along their longitudinal direction in steps from a largest cross-section to a smallest cross-section. The fluid lines 1116, 1117 connected to the media inlets 1112, 1113 open into the distribution chambers 1123 in the region of the largest cross-section in each case. The four line branches, each connected to a media outlet 1118, 1119, per dispensing terminals 1114, branch off from the distribution chambers 1123 successively in the longitudinal direction at different cross-sections. The distribution chambers 1123 are each designed as a stepped bore.

A second difference is that the connection pieces 1150 are permanently fixed to the metering head 1110 by means of screws, which can be removed without causing damage. Corresponding screw holes are provided in the metering head 1110, associated with each dispensing terminals 1114. In this case, it is therefore intended that the connection piece 1150 remains permanently on the metering head 1110 and should not be replaced with the connecting element.

The third difference is that eight electrodes 1131 are provided as actively controllable elements 1130 for liquid measurement, for example to determine a liquid presence in general, a position determination of the liquid or an indirect quantity determination of the passing liquid. A sensor unit consisting of two electrodes is provided for each channel, by means of which the beginning and the end of a liquid volume can be detected. In lieu of the simple sensor unit with two electrodes 1131, an electrode arrangement with a transmitting electrode, a receiving electrode and a first shielding electrode can also be provided, which are arranged coplanar on a plane and parallel to the fluid line 1116, 1117 and can be positioned above or below adjacent to the fluid line 1116, 1117, wherein the transmitting electrode and the receiving electrode are directly capacitively coupled in that they each have an adjacent edge with a dielectric between them, wherein preferably no shielding is provided between the transmitting electrode and the receiving electrode.

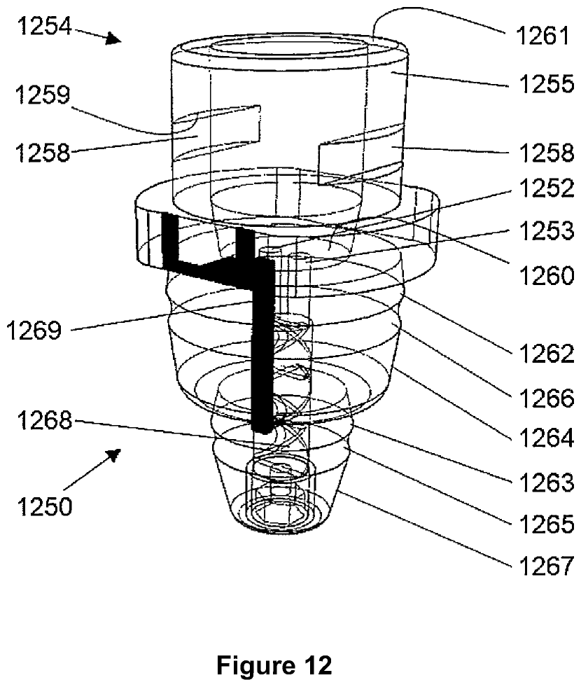

The connection piece 1250 shown in FIG. 12 has two initially fluidically separated fluid channels 1252, 1253, wherein each fluid channel 1252, 1253 of the connection piece 1250 communicates fluidically with one of two media outlets of a dispensing terminal (not shown) when inserted. The connection piece 1250 is designed identically to the connection piece 650 with regard to the connecting structure 1254, the hollow cylinder 1255, the guide grooves 1258, the undercut 1259, the sealing surface 1260, the upward-facing end face 1261, the stepped outer cross-sections 1262, 1263, the conical sealing surfaces 1264, 1265 and the annular grooves 1266, 1267. It differs in that it has a mixing structure 1268 as an integrated functional element in its lower region downstream of the fluid channels 1252, 1253. In this example, the mixing structure 1268 is designed as a so-called Kenics mixer. It further differs in that it has a temperature sensor 1269 as a second integrated functional element adjacent to the fluid channels 1252, 1253 and in parts to the mixing structure 1268. Compared to the example shown in FIG. 6, the contacts of the temperature sensor 1269 are guided outwards instead of the contact section 668 on the outer surface in the region of the hollow cylinder, more precisely on the ring-shaped projection, so that the same two electrodes 539 of the dispensing terminals 514 from FIG. 5 can be used to actuate the temperature sensor.

The metering head according to the invention can be used as a single or multi-channel pipette. The use is not limited to liquid transfer with pipette tips, but the metering head can also be equipped with other auxiliary devices such as a capillary, dispensing needle, cannula, Luer connector, channel orifice with sealing element, nozzle or a (complex) microfluidic head adapter. The metering head can be operated manually but also automatically, for example in line, room gantry or robot or cobot systems. The metering head is controlled via syringe pumps filled with air or liquid, for example. This makes it possible to use the microfluidic metering system as a pipette on the one hand and to convey fluids via the metering system on the other. It is also possible to use the microfluidic metering system as an actuator for microfluidic cartridges by applying individual pressures to the various dispensing terminals. The present invention thus enables sample enrichment and processing with sample analysis to be realised using the microfluidic metering system in combination with a microfluidic cartridge (lab-on-a-chip).

Various specific application examples are described below.

### Single Pipette Holder:

The metering head can be used as a single pipette holder with multiple microfluidic passages for different media (gases, e.g. air, and/or liquids, e.g. wash buffer). The advantages of this are:
Multiple use of the pipette tip and therefore fewer reaction vessels;
Due to the lower number of transfers of the sample to other reaction vessels, fewer losses of beads and thus of cells, CTCs (circulating tumour cells) or CTC clusters are to be expected;
Possibility of detaching the beads from the pipette without shear forces by drawing in air and the resulting bubble formation, which means that less loss of vitality can be achieved. This also enables the enrichment of complex cell clusters, e.g. CTC clusters

### Possible Application Scenarios are:

Cell cultures of stem cells. The advantages here are fewer pipette tips and contamination-free media addition (e.g. via Luer connectors) through additional microfluidic passages, which can be connected to medium reservoirs.
Enrichment of CTC clusters. The enrichment of CTC clusters is highly interesting for research, and in future certainly also for diagnostics. It is assumed that the analysis of CTC clusters can provide further information about the tumour disease and will be relevant not only for diagnostics but also for therapy. It is therefore necessary to ensure that the cluster structures are not destroyed during enrichment from a patient blood sample. Previous automated methods for enrichment, such as those used in the current CTCelect system, are based on draining the medium and resuspending the beads and the CTCs and CTC clusters bound to them by pipetting them up and down multiple times. The medium and the cells are repeatedly pressed through the narrow opening of the pipette tip. This process results in high shear forces, which can impair the vitality of the cells bound to the beads. In the case of CTC clusters, it can be assumed that the clusters are destroyed by flowing through the pipette tip up to 100 times.
The single pipette holder with microfluidic channels used here is suitable for normal pipetting on the one hand, but also for feeding wash buffers through an additional channel.
In this scenario, the invention enables the beads to be held magnetically in the pipette tip after the sample including the magnetic beads has been added and a subsequent incubation. After draining the blood sample, wash buffer is now added to the pipette tip through the additional opening of the pipette holder and the beads are released from the pipette by air bubbles flowing past the inner wall of the pipette by subsequently drawing air into the pipette tip. This is only possible because the pipette holder is not a reciprocating pipette. This makes it possible to take up air for a longer period of time, which is necessary for detaching the beads. After detachment, which is also the washing step, the beads (with CTC clusters) are magnetically attracted to the pipette again and the wash buffer is drained. This has the advantage already mentioned that the CTC clusters are not exposed to shear forces when being drained and aspirated through the narrow opening of the pipette tip. In addition, the wash buffers are dispensed into a sample tube, which also reduces the consumption of reaction vessels. A particularly relevant advantage is the prevention of bead loss in the reaction vessels, as the beads are not drained into the reaction vessels. This results in a reduced loss of CTCs or CTC clusters.
The single pipette holder makes it possible to connect the reservoir with wash buffer directly without a tube, e.g. in the form of a cartridge, and can therefore either be replaced more cheaply or cleaned more easily if necessary, thus preventing contamination of the wash buffer with microorganisms.

### Multiple Pipette Holder:

The metering head can be used as a multiple pipette holder in conjunction with a microfluidic channel system. The fluidic division and functionalisation of the channels is highly variable. The advantages of this are:
Variable pipette holder;
No need to change the pipettes;
By avoiding a reciprocating pipette, no second robot arm and no complicated control or mechanical adjustment of the pipette is required for operation;
The control unit is more robust than a hose control unit, for example, which also makes it easier to install.

### Possible Application Scenarios are:

General pipetting tasks, media distribution
Parallel analyses: Connection piece with measuring device
Parallel enrichment of CTCs. The advantage here is simple adaptation to existing demonstrators.
Immunoprecipitation and automated quantification of AB peptides from blood plasma of Alzheimer's patients.
Immunoprecipitation and a subsequent ELISA (enzyme-linked immunosorbent assay) are necessary for the detection of AB peptides from patient plasma. Immunoprecipitation is a time-consuming process, which is partly due to the plurality of washing steps required. The same applies to carrying out an ELISA. This procedure is carried out manually in most laboratories and therefore ties up labour. Fully automated processes are usually carried out on a large scale using the King Fisher system, which allows up to 96 samples (including controls) to be precipitated. However, this plurality of samples is only necessary for scientific investigations; in everyday clinical practice, the system is out of proportion, as a smaller number (e.g. no more than 8 patients) per day can be assumed in a clinic. In addition, a plurality of special consumables (plates, adapters for magnets) are required. In addition to the intensive preparation for the King Fisher system, which involves pipetting at least 6 plates of 96 wells, the immunoprecipitation is followed by analysis by ELISA, which is also very time-consuming due to intensive manual pipetting. In addition, the samples must be transferred manually to a pipetting robot.
Tests with the invention show that immunomagnetic enrichment can be carried out in pipette tips. For rapid analysis of patient samples, it is also necessary to process samples in parallel. This is made possible by using the metering system according to the invention as a multiple pipette holder. With the aid of adapted demonstrators, immunoprecipitation of multiple samples can also be carried out simultaneously.
Compared to the King Fisher system, the multiple pipette holder can hold volumes of over 2 mL per sample, leading to improved detection as more protein can be enriched. After mixing the sample with magnetic beads and a plurality of washing steps, the AB peptides are magnetically enriched in the pipette tips. The advantage of the multiple pipette holder in the case of AB peptide detection is the possibility of subsequent enrichment of an ELISA on a microfluidic cartridge automatically and without manual transfer. In the process, the multichannel pipette serves as a sampler and at the same time as an actuator for the cartridge. This means that the sample is transported fluidically in the cartridge. This is possible due to the metering system according to the invention, which differs from the known reciprocating pipettes in particular due to the lack of volume limitation. In addition, a simplified detection system can be used in the microfluidic cartridge, which does not need to have its own pump systems. Pumping is facilitated by the pump connected to the multi-channel pipette holder, as this enables “over-pipetting”. The distribution of air through the microfluidic channels has the advantage over individual tube connections that at most one tube connection needs to be laid in the systems. In addition, it is also conceivable to place pump systems, for example in the form of micropumps, directly on or integrated in the metering head. The option of using hose distributors also has disadvantages compared to the microfluidic metering system, as the hose connections are less robust and more complex to handle.
By modifying the metering system, as in the case of the above-mentioned “single pipette holder”, the system can be equipped with further advantages over hose connections.
Wash buffers can be transferred directly into the cartridge, even with multiple pipette holders, without having to “uncouple” pipettes from the cartridge. For the ELISA after immunoprecipitation, this means that the washing steps can follow directly after the addition of the sample and an incubation time. The “microfluidic collection system” thus enables automated immunoprecipitation and subsequent ELISA on the microfluidic cartridge.

The advantage of the metering system according to the invention is the simplicity of the underlying design through the use of high-precision manufactured components by conventional or mass production processes, similar to the known lab-on-a-chip. The invention also enables flexibility, i.e. adaptability to one or multiple applications and the combination of different liquid transfer systems (e.g. pipette tip sizes) with one metering head. This makes it possible, particularly in automated systems, for pipette tips to be changed quickly, for example.

Using the metering system for actuation simplifies the control of complex fluidic structures on a microfluidic cartridge and replaces pumps and valves as well as complex additional external control by an operator device. In addition to the classic pipette tips for transferring reagents or for actuating e.g. microfluidic cartridges, cannulas or dosing needles etc. can also be used. It is also possible to attach the dispensing terminals directly to the cartridge. Only a sealing element is then used as the connecting element. This creates a direct connection between the dispensing terminals of the metering head and the cartridge via a conical or flat sealing surface.

In summary, the main advantages are the low weight and small size. Furthermore, the variably equipped microfluidic metering system has applications for liquid transfer, pumping with negative and positive pressure, direct connection of the metering head to the microfluidic cartridge (without pipettes or other connectors), the possibility of simplifying the microfluidic cartridge and the processes to be transferred to a microfluidic structure, and greater flexibility in the order of reagent addition, transfer of different volumes, even at different times, without removing the pipette from the cartridge. Safe recirculation of volumes in pipette tips of the metering system, recurring removal and addition of reagents from the annexed microfluidic collection system (titre plate, cartridge). It is also possible to discard and drain them into a collection tray or container.

### LIST OF REFERENCE NUMBERS

100 Fluidic system
110 Metering head
111 Substrate
112 Media inlet
114 Dispensing terminal
116 Fluid line
118 Media outlet
120 Line branch
122 Quadruple branch
123 Distribution chamber
130 Actively controllable element
131 Valve
132 Microfluidic cartridge
133 Input opening
134 Channel structure
135 Centre opening
136 Socket
137 Receptacle
138 Luer connector
140 Connecting element
142 Pipette tip
143 Coupling element, outer casing surface
144 Coupling element, inner casing surface
150 Connection piece
152 Fluid channel
153 Fluid channel
156 Insertion direction
514 Dispensing terminal
518 Media outlet
519 Media outlet
530 Connection structure
531 Cylindrical bore
532 Centring pin
533 Annular gap
534 Centring cone
536 Guide channel
538 Recess
539 Electrode
650 Connection piece
652 Fluid channel
653 Fluid channel
654 Connection structure
655 Hollow cylinder
656 Insertion direction
658 Guide groove
660 Sealing surface
661 Upward-facing end face
662 Outer cross-sections
663 Outer cross-sections
664 Sealing surface
665 Sealing surface
666 Annular groove
667 Annular groove
668 Contact section
710 Metering head
711 Substrate
712 Media inlet
714 Dispensing terminal
716 Fluid line
718 Media outlet
720 Line branch
722 Single branch
730 Actively controllable element
731 Valve
745 Stem actuated valve arrangement
746 Tappet
747 Membrane
910 Metering head
911 Substrate
912 Media inlet
914 Dispensing terminal
916 Fluid line
918 Media outlet
920 Line branch
922 Single branch
930 Actively controllable element
931 Pump, rotary vane pump
940 Connecting element
942 Pipette tip
1010 Metering head
1011 Substrate
1012 Media inlet
1013 Media inlet
1014 Dispensing terminal
1016 Fluid line
1017 Fluid line
1018 Media outlet
1019 Media outlet
1020 Line branch
1022 Single branch
1030 Actively controllable element
1031 Valve, foil valve
1050 Connection piece
1110 Metering head
1111 Substrate
1112 Media inlet
1113 Media inlet
1114 Dispensing terminal
1116 Fluid line
1117 Fluid line
1118 Media outlet
1119 Media outlet
1122 Quadruple branch
1123 Distribution chamber, stepped bore
1130 Actively controllable element
1131 Electrode
1150 Connection piece
1250 Connection piece
1252 Fluid channel
1253 Fluid channel
1254 Connection structure
1255 Hollow cylinder
1258 Guide groove
1259 Undercut
1260 Sealing surface
1261 Upward-facing end face
1262 Outer cross-sections
1263 Outer cross-sections
1264 Sealing surface
1265 Sealing surface
1266 Annular groove
1267 Annular groove
1268 Mixed structure
1269 Temperature sensor

What is claimed is:

1. A metering head for receiving and metering at least one medium,
wherein metering head has:
one or multiple media inlets;
at least two dispensing terminals each having at least one media outlet;
and fluid lines, which connect the one or multiple media inlets to the at least one media outlet of the at least two dispensing terminals
wherein in at least one of the fluid lines an actively controllable element for manipulating and/or detecting the medium in the fluid lines is inserted.

2. The metering head according to claim 1 for receiving and metering at least two media with at least two fluidically separate media inlets, wherein the one or multiple dispensing terminals each have at least two fluidically separate media outlets.

3. The metering head according to claim 1, wherein the metering head has a substrate in which the fluid lines are formed as channels.

4. The metering head according to claim 1, wherein the fluid lines comprise a mixing section for combining at least two media to form a mixture.

5. The metering head according to claim 1, that wherein the fluid lines provide at least two alternative or parallel connections between the media inlet or inlets and the at least one media outlet of the at least two dispensing terminals, and in that the actively actuated element is at least one valve for selecting none, one or multiple of the connections.

6. The metering head according to claim 3, wherein the actively controllable element is a valve, the substrate has a sealing surface, the valve has a valve body which is arranged movably relative to the substrate, has a sealing surface and defines at least one channel for the selective connection and/or separation of fluid lines in the substrate, wherein the sealing surface of the valve body and the sealing surface of the substrate bear against one another in a liquid-tight manner.

7. The metering head (110) according to claim 1, wherein the actively controllable element comprises a pump for varying the conveying quantity and/or the conveying pressure of the medium or the mixture in the at least one fluid line).

8. The metering head (110) according to claim 1, wherein the actively controllable element comprises a sensor unit for detecting the presence, the volume, a physical, optical, chemical or biological property of the at least one medium or the mixture, or a combination of such measuring units.

9. The metering head according to claim 8, wherein the sensor unit comprises an electrode arrangement having a transmitting electrode, a receiving electrode and a first shielding electrode, which are arranged coplanar on a plane and can be positioned parallel to the fluid line and above or below adjacent to the fluid line, wherein the transmitting electrode and the receiving electrode are directly capacitively coupled by each having an adjacent edge with a dielectric therebetween, preferably no shielding being provided between the transmitting electrode and the receiving electrode.

10. The metering head (110) according to claim 1, wherein the actively controllable element comprises a heating element, a cooling element, an element for generating a magnetic field, an element for generating an electrical field, an element for coupling electromagnetic energy into the at least one medium or into the mixture, or a combination of such elements.

11. The metering head (44) according to claim 1, wherein a control unit connected to the actively controllable element.

12. The metering head (110) according to claim 11, wherein the control unit has a digital computing unit.

13. A fluidic system having a metering head according to claim 1, a microfluidic cartridge and at least one connecting element for fluidically connecting the metering head to the microfluidic cartridge,
wherein the dispensing terminals is configured to directly or indirectly receive the connecting element and
wherein the microfluidic cartridge has at least one input opening for connection to the at least one connecting element, and a channel structure which is fluidically connected to the input opening.

14. The fluidic system according to claim 13, wherein the metering head, in particular the dispensing terminal and/or the connecting element have means for retaining an inflow of fluids from the microfluidic cartridge into the metering head.

15. The fluidic system (100) according to claim 13, wherein the dispensing terminals has a sensor element for detecting the presence of a connecting element (140).

16. The fluidic system (100) according to claim 13, wherein at least one connection piece,
wherein the one or multiple dispensing terminals each has a connecting structure for receiving and a locking element for detachably fixing one of the connection pieces in each case
wherein the connection piece has a fluid channel,
wherein the connecting structure and the connection piece can be plugged into one another in an insertion direction and, when inserted, the fluid channel and the media outlet communicate fluidically,
wherein the locking element is arranged in the dispensing terminal so as to be movable in a guide direction transverse to the insertion direction between a locking position and a release position, wherein the locking element locks the connection piece in the locked position when inserted and releases it in the release position, and
wherein the connection piece is configured to directly receive the connecting element.

17. The fluidic system according to claim 16, wherein the one or multiple dispensing terminals each have at least two fluidically separate media outlets,
the connection piece has at least two fluidically separate fluid channels,
wherein, when inserted, each of the at least two fluid channels communicates fluidically with a respective one of the at least two media outlets.

18. The fluidic system according to claim 16, wherein the dispensing terminals has a sensor element for detecting the presence of a connection piece.

19. The fluidic system according to claim 16, wherein the dispensing terminal and the locking element are set up for automatic ejection of a connection piece.

20. The fluidic system according to claim 16, wherein the connection piece has a functional element integrated in the fluid channel, in particular an actively controllable element, for manipulating and/or detecting the medium, a passive mixing structure, an activatable mixer, a heating device, a cooling device, a passive or controllable magnet, a temperature sensor, an electrode or a means for retaining an inflow of fluids from the microfluidic cartridge into the metering head.

21. The fluidic system according to claim 13, wherein the connecting element is selected from the group consisting of: sealing ring, pipette tip, capillary, dispensing needle, cannula, Luer connector, channel orifice with sealing element, nozzle and microfluidic head adapter.

22. The fluidic system according to claim 13, wherein the microfluidic cartridge does not have an actively actuated movable element for controlling a fluid flow in the channel structure.

23. The fluidic system according to claim 13, wherein the microfluidic cartridge has a storage volume, for example for reagents, which is in communication with the channel structure.

24. The fluidic system according to claim 13, wherein the at least one connecting element and the input opening have coupling elements engaging in an interlocking manner for liquid-tight connection.

25. The fluidic system according to claim 13, at wherein the input opening has a funnel-shaped centring opening.

26. The fluidic system according to claim 13, wherein the microfluidic cartridge has a sample access for receiving a sample to be analysed and a channel structure connecting the input opening to the sample access.

27. The fluidic system according to claim 13, wherein the microfluidic cartridge is a microfluidic measuring chip.

28. The fluidic system according to claim 27, wherein the microfluidic measuring chip is configured for carrying out measurements of the emission and/or scattering of light by a fluid sample in an operator device, wherein the measuring chip has a base plate made of a transparent polymer material and the channel structure is formed in the base plate and comprises at least one sensing cell for receiving a fluid sample and fluid channels for the supply and discharge of fluid to and from the sensing cell.

29. The fluidic system according to claim 13, wherein at least one of the components metering head, microfluidic cartridge, connecting element and connection piece is provided with a machine-readable code, in particular with an RFID tag, for automatic recognition thereof.
